(19) United States
(12) Patent Application Publication
(10) Pub. No.: US 2018/0215191 A1
(43) Pub. Date: Aug. 2, 2018

(54) RETRACTABLE TYPE WRITING INSTRUMENT

(71) Applicant: MORRIS CORPORATION, Inchon-si (KR)

(72) Inventor: Hyun-son YOON, Yongin-si (KR)

(73) Assignee: MORRIS CORPORATION, Inchon-si (KR)

(21) Appl. No.: 15/423,278

(22) Filed: Feb. 2, 2017

(51) Int. Cl. B43K 3/04; B43K 24/16

(52) U.S. Cl. CPC B43K 3/04; B43K 24/16

(57) ABSTRACT

The present invention has an object to provide a retractable type writing instrument, in which a nib is fixed to a cartridge by means of a nib fixing means, and the nib fixing means has an air circulation passage formed in a coupling part thereof, such that it is possible to prevent the air circulation passage from being exposed, thus to enhance an aesthetic appearance when using the writing instrument, and prevent an occurrence of defective writing by always stably supplying air due to prevention of foreign matters from inflowing into the cartridge. The retractable type writing instrument, including: a body case including a knock part installed therein to be operated by pushing, and a cartridge inserted into a hollow inside thereof; and a nib fixing means coupled to an end of the cartridge so as to connect a nib housed therein with the cartridge.

### BACKGROUND OF THE INVENTION

### 1. Field of the Invention

The present invention relates to a retractable type writing instrument, and more particularly, to a retractable type writing instrument such as a ballpoint pen, highlighter, roller pen, board marker pen, oil-based marker pen, magic pen, plastic pen, or marking pen, in which a retractable type nib protrudes from a front opening of the writing instrument only when using the writing instrument, and the nib is positioned in the writing instrument when not in use.

### 2. Description of the Related Art

Typically, a writing instrument is used to record information on a surface using a recording medium, and has various forms and methods such as a ballpoint pen, highlighter, roller pen, board marker pen, oil-based marker pen, magic pen, plastic pen, or marking pen. Most of these types of writing instruments are generally retractable type writing instruments which are provided with a cylindrical body, a nib housed in the body, and a pushing member provided in the body so as to press the nib.

FIG. 1 is a perspective view illustrating a conventional retractable type writing instrument.

As illustrated in FIG. 1, the conventional retractable type writing instrument includes a body case 10 having a front opening 12 formed in one end thereof, a knock part 20 coupled to the body case 10 so as to allow a nib 50 to protrude from or be retracted into the front opening 12, a clip part 30 attached to the body case 10, and a cartridge 40 slidably installed in the body shaft 10 together with a spring (not illustrated). The nib 50 is provided on an end side of the cartridge 40.

In addition, the cartridge 40 has an air passage 42 formed on the end side thereof protruding together with the nib 50 from the front opening 12.

However, as illustrated in FIG. 1, when the nib 50 protrudes from the front opening 12, the air passage 42 also protrudes to an outside, thereby deteriorating an aesthetic appearance of the air passage 42. In particular, if foreign matters are trapped in the protruded air passage 42, a vacuum may occur due to an unstable supply of air, thereby causing a problem of defective writing due to ink contained in the cartridge 40 not being properly supplied to the nib 50.

As a prior art related to the present invention, there is an air hole structure of a ball-point pen disclosed in Korean Utility Model Registration No. 20-0438707 (Published on Mar. 29, 2008).

### SUMMARY OF THE INVENTION

In consideration of the above-mentioned circumstances, it is an object of the present invention to provide a retractable type writing instrument, in which a nib is fixed to a cartridge by means of a nib fixing means, and the nib fixing means has an air circulation passage formed in a coupling part thereof, such that it is possible to prevent the air circulation passage from being exposed, thus to enhance an aesthetic appearance when using the writing instrument, and prevent an occurrence of defective writing by always stably supplying air due to prevention of foreign matters from inflowing into the cartridge.

Another object of the present invention is to provide a retractable type writing instrument capable of using various forms and types of nibs by employing a nib fixing means which can be used for general purpose in a body case and a cartridge, such that manufacturing costs may be reduced.

In order to accomplish the above objects, according to the present invention, there is provided a retractable type writing instrument, including: a body case including a knock part installed therein to be operated by pushing, and a cartridge inserted into a hollow inside thereof; and a nib fixing means coupled to an end of the cartridge so as to connect a nib housed therein with the cartridge.

Preferably, the nib fixing means includes a coupling part integrally formed therewith, which is formed in a hollow cylindrical shape and has a reduced diameter toward the cartridge so as to be inserted therein, and the coupling part has an air circulation passage formed therein by cutting in an axial direction to be communicated with an outside.

In addition, at least one of the air circulation passages may be formed in the coupling part.

Further, the coupling part may further include a stepped groove formed therein with a reduced diameter, and the stepped groove may be positioned in a stepped portion formed inside of the end of the cartridge so as to prevent a separation therebetween, and the coupling part may be formed so as to have an outer diameter slightly larger than an inner diameter of the stepped portion.

In accordance with the retractable type writing instrument according to the present invention, the nib is coupled to the cartridge through the nib fixing means containing the nib, and the air circulation passage is formed in the coupling part of the nib fixing means, such that it is possible to prevent the air circulation passage from being exposed, thus to enhance an aesthetic appearance when using the writing instrument, and prevent an occurrence of defective writing by always stably supplying air due to prevention of foreign matters from inflowing into the cartridge.

Further, according to the present invention, it is possible to use various forms and types of nibs by employing the nib fixing means which can be used for general purpose in the body case and the cartridge, such that manufacturing costs may be reduced.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a conventional retractable type writing instrument;

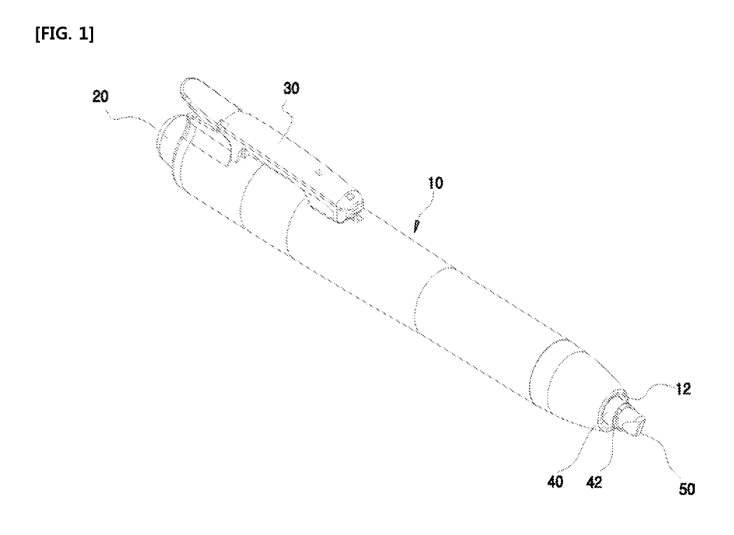

FIG. 2 is an exploded perspective illustrating a retractable type writing instrument according to the present invention;

FIG. 3 is a cross-sectional view illustrating a cartridge and a nib fixing means of the writing instrument according to the present invention; and

FIG. 4 is a perspective view illustrating a state of use of the retractable type writing instrument according to the present invention.

### DETAILED DESCRIPTION OF THE INVENTION

Hereinafter, a retractable type writing instrument according to the present invention will be described in detail with reference to the accompanying drawings in terms of configuration and operation thereof.

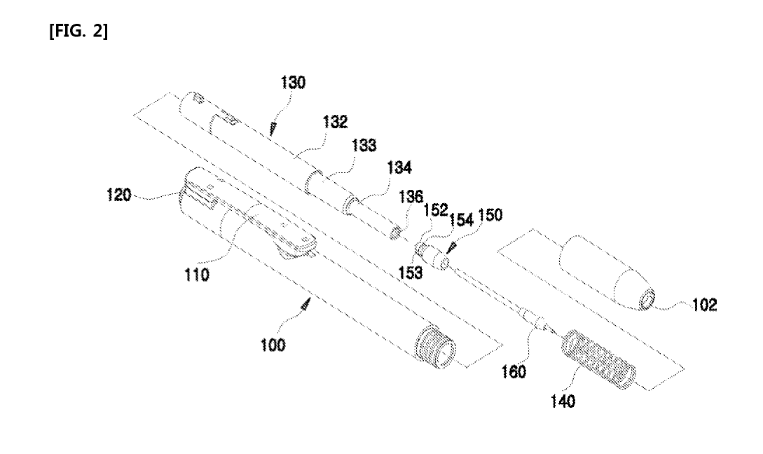

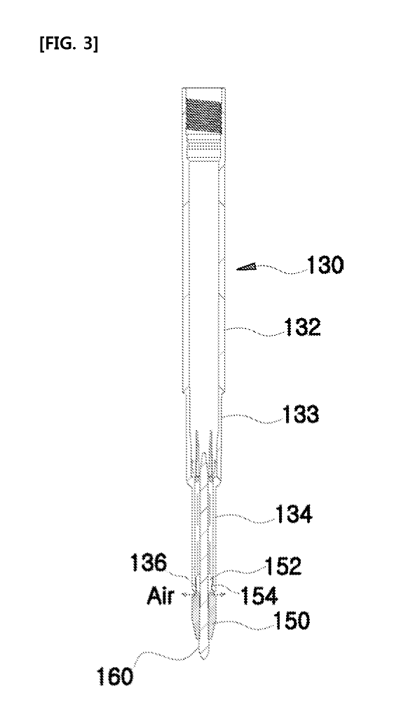

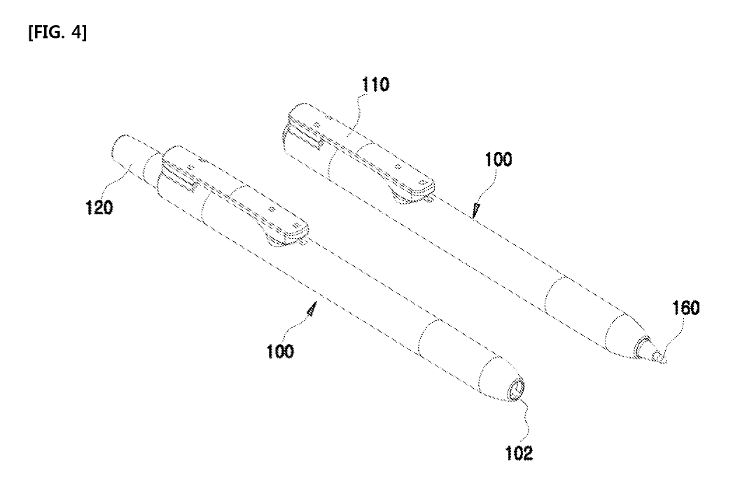

FIG. 2 is an exploded perspective illustrating a retractable type writing instrument according to the present invention, FIG. 3 is a cross-sectional view illustrating a cartridge and a nib fixing means of the writing instrument according to the present invention, and FIG. 4 is a perspective view illustrating a state of use of the retractable type writing instrument according to the present invention.

As illustrated in FIG. 2, the retractable type writing instrument according to the present invention generally includes: a body case 100, a cartridge 130 slidably inserted into the body case 100, and a nib fixing means 150 installed in the cartridge 130 while containing the nib 160.

First, the body case 100 may be made of a synthetic resin material or a metallic material using an injection molding or a mold forming method, and may have a hollow pipe or tube shape.

The body case 100 may be formed of one or two cases, and in the illustrated example, two cases are coupled with each other by fastening with a screw or tight fitting. One cone-shaped case may have a front opening 102 formed in one end thereof.

In addition, a clip part 110 may be installed on a circumferential surface of the body case on a side opposite to the front opening 102, which is coupled thereto for allowing an organic clipping or releasing operation thereof as a clip means therein.

Further, the knock part 120, which is installed in the body case 100 so as to make the nib 160 protrude from or be retracted into the front opening 102 by a pushing operation, may be installed adjacent to the clip part 110.

The knock part 120 may be installed in the body case so as to transfer a force to the cartridge 130 by the pushing operation of a user, and has a tube shape having a small diameter circumferential surface and a large diameter circumferential surface formed in a layer. Herein, one end of the small diameter circumferential surface is opened and the other end of the large diameter circumferential surface is closed.

Meanwhile, the cartridge 130, which is inserted into the body case 100 together with the spring 140, corresponds to an ink storage portion, and may have an internal volume of a predetermined capacity.

Such a cartridge 130 has a tank part 132 having a largest diameter, a connection part 133 having a relatively smaller diameter than the tank part 132, and a nib extension shaft part 134 having a relatively smaller diameter than the connection part 133, which are integrally formed therewith in such a manner that the diameters thereof are sequentially decreased toward the nib while forming layers.

Further, the nib 160 is coupled to an end of the nib extension shaft part 134 through a nib fixing means 150, so that any content (for example, ink) etc. stored in the tank part 132 may be supplied thereto by a common ink supply method (for example, a capillary phenomenon, pressure difference, suction, etc.) from the tank part 132 according to a common supply method corresponding to types of the writing instrument.

In addition, a stepped portion 136 having a predetermined length may be formed by protruding from inner wall of the end of the cartridge 130 coupled with the nib fixing means 150.

The spring 140, which is inserted into the body case 100 together with the cartridge 130, may be placed on a steeped face of the connection part 133 near the tank part 132 so as to be supported thereby.

Thereafter, the spring 137 plays a role of pressing the cartridge 130 in an axial direction within a stroke distance of the cartridge 130 during the operation.

For example, when the cartridge 130 and the knock part 120 move in a forward direction by a predetermined stroke distance, the spring 137 is compressed while elastic energy is restored therein, which will act as an elastic restoring force when the spring returns from the compressed to an extended state. Herein, the predetermined stroke distance of the cartridge 130 is equal to the stroke distance of knock part 120 or to a distance between an original position and a position where the nib 160 protrudes therefrom. In addition, when the cartridge 130 and the knock part 120 are in the released state in which they can return in a backward direction, the spring 137 plays a role of returning the components coupled to the cartridge 130 including the knock part 120 to the original position by the elastic restoring force thereof.

The nib fixing means 150, in which the nib 160 is passed through and housed, may be made of a synthetic resin material or a metallic material using an injection molding or a mold forming method, and may be formed in a hollow cylinder shape.

The nib fixing means 150 includes a coupling part 152 integrally formed with one side thereof having a predetermined length with reduced diameter toward the cartridge 130 so as to be inserted therein. The coupling part 152 has an air circulation passage 153 cut in an axial direction to be communicated with an outside.

In addition, at least one of the air circulation passages 153 may be formed in the coupling part 152, but it is preferable that a pair of air circulation passages 153 are formed to face each other, and the length thereof is the same as an entire length of the coupling part 152.

Further, the coupling part 152 may have a stepped groove 154 formed therein with a reduced diameter. The stepped groove 154 may be fitted with the stepped portion 136 of the cartridge 130 so as to prevent a separation therebetween.

Furthermore, the coupling part 152 may be formed so as to have an outer diameter slightly larger than an inner diameter of the stepped portion. The reason is that, the diameter of the coupling part 152 can be resiliently temporarily reduced during being inserted into the cartridge 130 due to the cut air circulation passage 153.

Hereinafter, nib protruding and retracting operations of the retractable type writing instrument according to the present invention having the above-described configuration will be described with reference to FIGS. 3 and 4.

When assembling the writing instrument, the cartridge 130 and the spring 140 are positioned inside the body case 100, and the knock part 120 is fastened to one end of the cartridge 130 in a coupling method such as tight fitting or fastening with a screw.

Then, the nib fixing means 150, in which the nib 160 is passed through and housed, is coupled to the one end of the cartridge 130.

At this time, when inserting the nib fixing means 150 by tight fitting, the insertion thereof into the cartridge 130 is performed while the diameter of the coupling part 152 is resiliently reduced due to the cut air circulation passage 153. After the insertion, the stepped groove 154 of the coupling part 152 may be fitted with the stepped portion 136 of the cartridge 130 so as to prevent the separation therebetween.

At the same time, the coupling part 152 having the reduced diameter to some extent may more firmly fix the nib 160 to prevent it from being separated.

In addition, as illustrated by an arrow in FIG. 3, air circulation may be naturally performed through the air circulation passage 153 of the coupling part 152 coupled to the cartridge 130, and even when using the writing instrument as illustrated in FIG. 4, since the air circulation passage 153 is not exposed to the outside, it is possible to provide a beautiful appearance, and always maintain smooth circulation of air by blocking foreign matters from being introduced.

Further, in the present invention, the nib is coupled to the cartridge 130 through the nib fixing means 150, rather than the method of directly inserting the nib into the cartridge 130, such that, the nib 160 may be assembled to the same one body case 100 using the nib fixing means 150 in any nib type such as a felt nib, roller tip, brush pen nib, plastic nib, or needle tip, regardless of shapes or types thereof.

While the present invention has been described with reference to the preferred embodiments and modified examples, the present invention is not limited to the above-described specific embodiments and the modified examples, and it will be understood by those skilled in the related art that various modifications and variations may be made therein without departing from the scope of the present invention as defined by the appended claims, as well as these modifications and variations should not be understood separately from the technical spirit and prospect of the present invention.

### DESCRIPTION OF REFERENCE NUMERALS

100: body case,
102: front opening
110: clip part,
120: knock part
130: cartridge,
132: tank part
133: connection portion,
134: nib extension shaft part
136: stepped portion,
140: spring
150: nib fixing means,
152: coupling part
153: air circulation passage,
154: stepped groove
160: nib

What is claimed is:

1. A retractable type writing instrument, comprising:
a body case including a knock part installed therein to be operated by pushing, and a cartridge inserted into a hollow inside thereof; and
a nib fixing means coupled to an end of the cartridge so as to connect a nib housed therein with the cartridge,
wherein the nib fixing means includes a coupling part integrally formed therewith, which is formed in a hollow cylindrical shape and has a reduced diameter toward the cartridge so as to be inserted therein, and
the coupling part has an air circulation passage formed therein by cutting in an axial direction to be communicated with an outside.

2. The retractable type writing instrument according to claim 1, wherein at least one of the air circulation passages are formed in the coupling part.

3. The retractable type writing instrument according to claim 1, wherein the coupling part further includes a stepped groove formed therein with a reduced diameter, and the stepped groove is positioned in a stepped portion formed inside of the end of the cartridge so as to prevent a separation therebetween, and
the coupling part is formed so as to have an outer diameter slightly larger than an inner diameter of the stepped portion.
